(19) United States
(12) Patent Application Publication
(10) Pub. No.: US 2006/0091149 A1
(43) Pub. Date: May 4, 2006

(54) Miniature model car business card dispenser

(76) Inventor: Taiming Chen, Los Gates, CA (US)

Correspondence Address: Taiming Chen, 150 Forest Hill Dr, Los Gates, CA, 95032, US

(21) Appl. No.: 11/238,771

(22) Filed: Sep. 29, 2005

Related U.S. Application Data
(60) Provisional application No. 60/624,152, filed on Nov. 2, 2004.

(51) Int. Cl. B65G 59/00

(52) U.S. Cl. 221/248

(57) ABSTRACT

A miniature model car business card dispenser has a business card dispenser mechanism enclosed inside of a miniature model car's body. A machine operated lid similar to one on a real car can be opened and reveal an opening on the model car such as trunk opening or engine bay. The lid, when opened, allows passage of business card deck that was stored inside. Card deck can be pushed out or pulled in through model car's opening. When lid is closed, no dispenser mechanism can be seen from outside and the whole thing looks just like a regular model car. A underneath car trigger switch is provided for signaling dispenser operation. A set of electrical-mechanism includes a motor drive, slide on track and gear set are used to raise or lower the card deck as well as the lid.

### CROSS-REFERENCE TO RELATED APPLICATIONS

This application is related to and claims priority from U.S. Provisional Patent Application Serial No. 60/624,152 filed on Nov. 26, 2004

### FIELD OF THE INVENTION

The present invention relates, in general, to a business card dispenser enclosed inside of a miniature model car.

### BACKGROUND OF THE INVENTION

Business card is essential tool in business world. It serves a purpose to remind people about its originator's basic information and it delivers personal impression. Card owner wants their card to be impressive, sometime even the method to deliver them. One way to deliver business card is to use business card dispenser.

Some business card dispensers serve only functional purpose. They hold cards and dispense one when requested. The other business card dispensers simply just hold cards with decorated shape.

People are known to have certain emotional attachment to vehicles. Personal car sometime is more than just basic transportation. It often reflects one's social status and marks one's success. It's often true that in business world, many businessmen or women own luxury or even exotic cars that hey don't afraid of letting people know. Sometime even brag about what kind of car they own or want to own. A nice built miniature model car not only considered a nice decoration item; sometime even an art piece for display. That's why a miniature model car is not uncommon to be seen as desktop decoration.

U.S. Pat. No. 4,848,699 to Jing-Lin discloses a video tape rewinder enclosed inside a car shape body.

U.S Pat. No. 6,565,412 to Thrasher; Matthew S. discloses a Hood and trunk lid lifting mechanism for model car.

A business card dispenser enclosed in a model car fulfills the need of handing out business information and impress people even more. This invention has been made to delivery business cards for easy access and when not using its business card dispenser function, it's decorative just like a miniature model car as an additional value.

### SUMMARY OF THE INVENTION

This miniature model car business card dispenser has a build-in electric-mechanical system that extends and extracts a business card deck in and out through the model car's existing opening port such as engine hood or trunk lid. So that after the card deck has completely come down and stored inside the model car's body with lid closed behind, there is no extra seam to be seen. That is essential for preserving the look of a miniature model. This invention use one end of car for business card access port and use another end to function as trigger switch. In this document, our figures and example shows that we use car's rear end (trunk lid) as card access port and front end (engine hood) as switch end. This is just for illustration purpose, not a limit for our claim.

Like a real car, model car in this invention stands above ground level via 4 wheels. Wheels axels are connected to car body by spring loaded suspension links. Car body can move up and down a little bit against wheel stands. One push at car's switch end compresses the suspension spring and lowers the car's switch end. As the suspension reach to the bottom, an electrical switch is then triggered to generate a signal to move card deck and trunk lid to either exhibition or camouflage mode. A circuit and a set of sensors keep the electrical motor moving and stopping when the card deck is at desired positions. There is no need to keep pressing the car down while the dispenser is working.

At one touch of car's switch end (engine hood), the card access end (trunk lid) opens before a deck of business cards slides out and holds stop there for people to access them. Another touch on the switch end retrieves the deck of card back into car first then the card access lid (trunk lid) closes behind it, leaving no trace of business card or any seam on the model car. One of our goals is keep the authentic look of the model car, leave nothing extraterrestrial on the outside or any crack/seam that doesn't belong to the original car.

### BRIEF DESCRIPTION OF THE DRAWINGS

FIG. 1 is a perspective view of a model car, particularly showing the front and back suspensions and a trigger switch at open position.

FIG. 2 is the same perspective view of a model car as FIG. 1. Except the front suspension is pressed by user, trigger switch is at closed position.

FIG. 3 is a perspective view of a model car, particular showing a deck of card inside and its trunk lid closed.

FIG. 4 is the same perspective view of a model car as FIG. 3. Except its trunk lid is open, card deck remain inside.

FIG. 5 is the same perspective view of a model car as FIGS. 3 and 4. Except its trunk lid is open and its card deck is at display position for access.

FIG. 6 is a plan view of card deck and trunk lid operation assemble, in fully enclosed mode

FIG. 7 is another plan view of card deck and trunk lid assemble as FIG. 6. Except the trunk lid is open.

FIG. 8 is another plan view of card deck and trunk lid assemble as FIGS. 6, 7. Except the trunk lid is open and card deck is at display position.

FIG. 9 is a circuit diagram that shows motor controlling circuit and all needed position sensors.

### DETAILED DESCRIPTION OF THE PREFERRED EMBODIMENT

Prior to proceeding to the more detailed description of the present invention, it should be noted that, for the sake of clarity and understanding, identical components which have identical functions have been identified with identical reference numerals throughout the several views illustrated in the drawing figures.

The car shape card dispenser as show in FIGS. 1, 2, 3, 4 and 5 comprises a cast car body 1, two front wheels 2, a set of front suspension 54, two rear wheels 5, a set of rear suspension 55, and a trunk lid 8 rotates around pivot point 15.

Inside the model car body, there is a card deck and trunk lid operation assemble comprise a moveable trunk lid 8 and its supporting structure 53 that rotate around a pivot point 15, a card deck holder 9 moves along track that from its store position to trunk opening, a deck of cards 10 which is stored inside the card deck holder 9 in this illustration, a slide 11 moves along a track that is parallel to the tack of card holder, a base 12, a contact final driving head 13 and a motor drive 14.

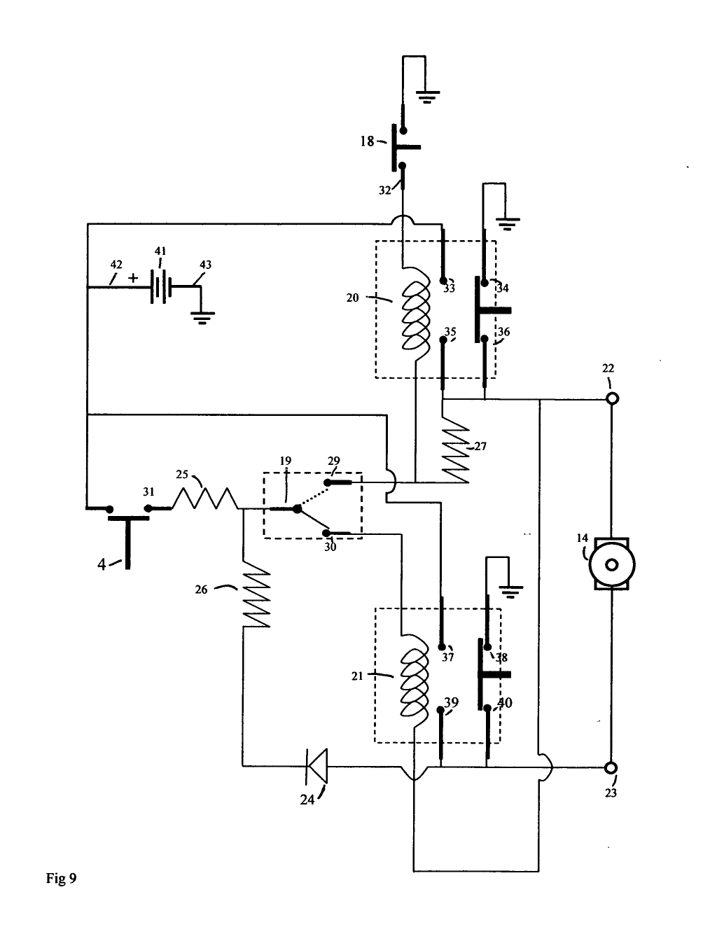

Under the car's chassis, there is a trigger switch 4. A battery 41 provides needed DC power to drive the reversible DC motor 14 thru a set of electrical control circuit 49 to perform all the dispenser actions. Detail of electrical circuit 49 is shown in FIG. 9.

FIG. 1 shows the model car has 4 wheels, show as 2 and 5, they ride on suspension springs, 54 and 55, in a manner similar to a real car. The trigger switch means 4 to active all functions for business card dispenser hides under the car chassis and around the area of front wheels 2. When model car stands by itself along, both suspension sprint set 54 and 55 are in free stand mode which lift the car body 1 and trigger switch 4 clear from contacting against ground so switch 4 remain opened.

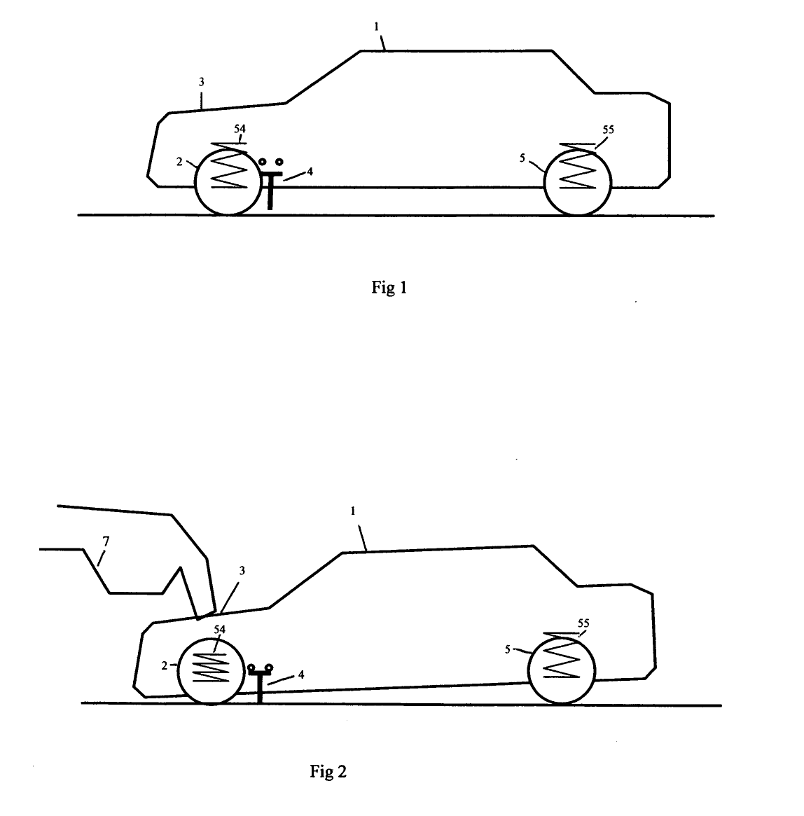

FIG. 2 shows what happen when user 7 provides a push on model car's front 3, common know as engine hood, it compresses the front suspension springs 54 and the car's front 3 gets lowered. Trigger switch 4 get pushed down and make contact against ground and change state from open to close. Trigger switch 4 change its state back to open when user releases pressure on model car, back to state shown in FIG. 1. The state change of trigger switch 4 serves as a signal to the electrical circuit 49.

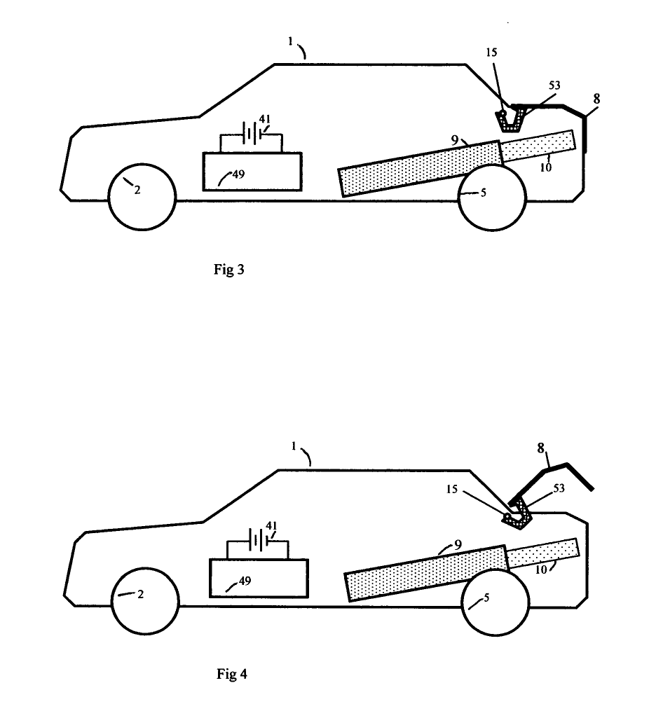

FIG. 3 shows battery 41 and circuit 49 is embedded inside model car body 1. It also show dispenser in home state. The deck holder 9 and card deck 10, which is stored inside card deck holder as illustration, remain fully hidden inside the model cars body 1 with model car's trunk lid 8 closed.

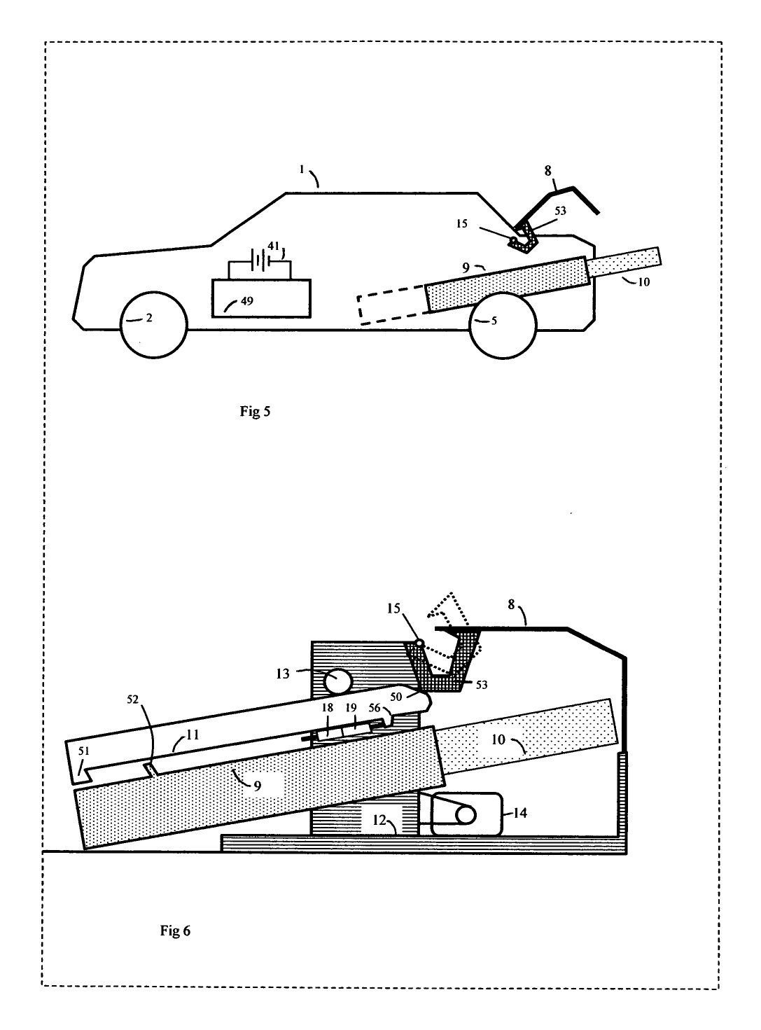

FIG. 4 shows when card dispenser starts to work, it first opens the trunk lid 8, which turning around a pivot point 15, before extends the card holder 9. Card deck 10 stored within the card holder 9 will pass through the trunk opening space left by opened trunk lid 8.

FIG. 5 shows card dispenser is at display position. Card deck holder 9, with card deck 10 stored inside, moves toward the model car's trunk opening. The exposed part of card deck 10 reaches to outside from trunk opening while card deck holder 9 still remains inside. This shows the display mode of card dispenser. When retrieving operation starts, the card holder 9 gets back inside along the same track as moving out, before the trunk lid 8 start to close, such as shown in FIG. 4. Then the trunk lid 8 closed to fully complete retrieving operation, back to the state as FIG. 3 shows.

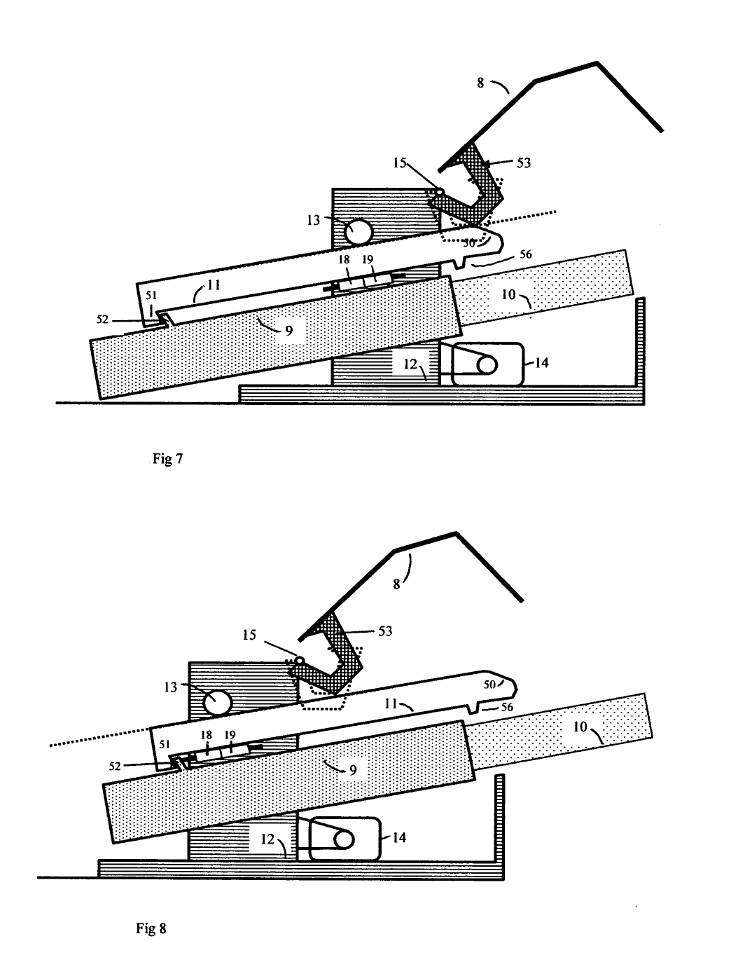

FIGS. 6, 7 and 8 show how the card dispenser mechanism assembly works for business card dispenser function. The card holder 9 and a moving slide 11 are moving parallel along their tracks on operation assemble base 12. The driving motor 14 transfer its torque thru a set of belt and gears on the side of base 12 and drive the final driving head 13. The head 13 then moves the slide 11 via friction force, forward or backward. When the dispenser is extending, the slide 11 first push open the trunk lid 8. The slide 11 has a sloped edge 50 that make initial contact and then pushes against trunk lid's support structure 53 to force it to rotate around the pivot point 15 to open position. While doing so, the contact point 56 on slide 11 will also leave home sensor switch 19 and set status to not-home. After the trunk lid 8 is fully open, the tail-hook 51 on moving slide will hook up with card holder's catch-up hook 52 and take along the card holder 9 to move with it till card holder 9 is at its display position. Meanwhile the trunk lid's supporting structure 53 is still above the moving slide and gliding on it. Once the moving slide 11 reaches to its most extended position, the stop limit sensor switch 18, part of control circuit, will be reached and activated by the card holder's catch-up hook 52. This action will cut the power to motor 14 and stops the whole movement. The business card deck 9 will be exposed outside to the trunk opening for accessing.

The retrieving operation takes another direction. One push by user on the model car's front end toggles the trigger switch 4 again. However, the circuit will control the motor 14 rotates toward the other direction and drives slide driving head 13 rotate toward the other direction to take slide 11 back into model car's body. The card holder 9 along with the card deck 10 either are dragged by a loaded spring, loaded by extending action, or just being pulled down by gravity, fall back to its final store position. After that, trunk lid's support structure 53 will glide to slide's sloped edge 50 and starts being pull by gravity to rotate downward to close. Reaching its final store position, the slide 11 will set the home sensor switch 19 to its home position 29, which tells the circuit to cut power toward motor and become stopped state.

Referring now to the embodiment of electrical circuit means of FIG. 9, a battery 41 is used to provide DC power to the entire circuit as well as electrical motor 14. Trigger switch 4 connects DC power positive 42 to point 31 when the switch is activated. There are three resistors 26, 27 and 31 are used to protect circuit from short circuit. Two DC relays mean 20, 21 have six connection points each. Two for its electric-magnetic coil and the other four are two pair of contact points of relay switch. The switch will set one pair of contact points to close circuit and the other pair is set to open depends on if the coil is applied with electrical current. Relay 20 has switch connect point 34 and 36 closed; 33 and 35 open when there is no electrical current applied to its coil. Relay 21 has switch contact points 38 and 40 closed; contact points 37 and 39 opened when no electrical current is applied to its coil. When relay 20's coil is powered, switch will connect point 33 and 35 closed while leave 34 and 36 opened. When relay 21's coil is powered, switch will connect point 37 and 39 closed while leave 38 and 40 opened.

The extend operation which means the moving slide 11 started from home position, as shown as FIG. 3 or 6, push trunk lid 8 open and move card deck holder 9 out and stop at top limit position, as shown as FIGS. 5 and 8. When the slide 11 is at home position means the slide 11 is fully back and does not push against card deck holder 9 or trunk lid supporting structure 53, as show in FIG. 6. The slide home sensor switch means 19 is connected to home position 29. When user presses model car's front end and toggles trigger switch 4, DC power positive come from 42 cross over to point 31 and then will deliver to first DC relay 20's coil and turn the switch to connect point 33 and 35. Slide top limit switch means 18 will change to open only if the slide is hitting its top limit which pushed card holder 9 to its display position, as show in FIG. 8. The top limit switch 18 shall be closed if the slide is at its home position. DC power positive from point 33 cross over to point 35, not only goes to point 22 to driver motor 14 to roll out, it also goes through resister 27 and keep DC relay 20's coil powered when user release trigger switch 4, which means point 31 is opened from DC power positive. Motor 14 gets ground from point 40 which is closed to point 38 since relay 21's coil isn't powered. Once this DC current form a loop around relay 20's coil, it will continue power the motor and relay 20's coil itself even toggle switch 4 is opened or slide home sensor switch 19 has turn to away 30 position, which is definitely happening if motor 14 is driving the slide 11 to move out. This keeps motor 14 and slide 11 moving till the slide 11 hits it top limit switch 18 and change its state to open. When switch 18 is open, the DC current loop powered relay 20 coil become open and releases relay 20's switch connect back to point 34 and 36 and leave point 33 and 35 opened, which also stops sending power to motor contact point 22, hence motor 14 will be stopped.

The other operation this circuit is able to perform is retrieving operation. When the slide 11 isn't at home position, the slide home sensor switch 19 is connected to away position 30. When user presses model car's front end and toggles trigger switch 4, DC power come from 42 will cross over to point 31 will deliver to second DC relay 21 and turn the switch to connect point 37 and 39. DC power positive from point 37 to point 39 not only goes to motor contact point 23 to start driving motor 14, it also goes through diode 24 and resistor 26 to keep DC relay 21's coil powered when user releases trigger switch 4, which means point 31 is opened from DC power positive. Motor 14 gets grounded from point 36 which is closed to point 34 since relay 20's coil isn't powered.

I claim:

1. A business card dispenser, comprising:
(a) a housing having a car-shape configuration, including
(i) a body resembling a car's body,
(ii) a set of wheels connect to car's body via spring suspensions for supporting model car's body and keeping trigger switch clear of contact to ground when no extra force is pressing on car body, and both ends or the whole car body can be lowered when certain amount of force is pressing on model car's body,
(iii) a trigger switch mounted underneath front end of car body for detecting if front end of car body had been lowered by external force, and
(iv) a lid resembling a car's trunk lid and pivotably mount on the base of business card dispenser assemble for movement between a lid-open position in which business card deck can pass through the opening, and a lid-closed position in which the card dispenser and card deck are fully contained within the housing and can't be seen from outside;
(b) a business card dispenser assemble means mounted inside the car shape housing for joint movement therewith, and operative for angularly opening trunk lid to lid-open position, and for pushing business card deck outward to display position when lid is completely open, and for pulling business card deck inward to store position, and for angularly closing trunk lid to lid-close position when card deck is at store position, said business card dispenser assemble including
(i) a electrical powered motor which can rotate at both directions,
(ii) a set of gearing to transfer motor's torque to final driving head,
(iii) a driving head to drive slide moving back and forth,
(v) a moveable card deck holder along a track for movement between store and display positions,
(iv) a moveable slide means moves along a track parallel to track of card holder between home and stop-limit position, and for carrying card holder to move with it, and for pushing the support beam of the trunk lid to move angularly, and
(vi) a base which provides mounting places for pivot axis of trunk lid, motor, gears and tracks for slide and card deck holder;
(c) a circuit to control motor driving to drive slide, card holder and lid moving between two desired positions, said circuit including
(i) a DC relay to keep motor powered when moving slid outward,
(ii) a DC relay to keep motor powered when moving slid inward,
(iii) a switch circuit for user to trigger actions, switch will set to close when user push the front end of car lowered,
(iv) a switch circuit to change in between slid home or not-home position according to if slide is at home position,
(v) a switch circuit to set to closed when slide and card holder are at their top limit position, and
(vi) a power source means battery for powering the circuit and electrical motor.

2. The card dispenser as recited in claim 1, wherein the lid resembles a car's engine hood and card deck come out from model car's engine bay opening. The engine hood pivotably mount on the base of business card dispenser operation assemble, and the trigger is mounted under rear end of model car, switch will set to closed when user push the rear end of car lowered.

3. The model car dispenser as recited in claim 1 or 2, wherein the business card deck is replaced with other item for displaying such as jewel.

4. The card dispenser as recited in claim 1, 2 or 3, wherein the model car's body is stand on a fixed platform with non-functional wheels, and a push button is mounted on platform that works as trigger switch.

5. The card dispenser as recited in claim 4, wherein the power source, battery, is kept inside the platform.

6. The card dispenser as recited in claim 4, wherein the power source is coming from AC-DC adaptor that connects to wall socket.

7. The card dispenser as recited in claim 1, wherein the model has headlights or taillights are illuminated during the movement the card deck.
